(19) United States
(12) Patent Application Publication
(10) Pub. No.: US 2026/0098564 A1
(43) Pub. Date: Apr. 9, 2026

(54) PERMANENT MAGNETIC LEVITATION BUFFER ROLLER AND CONTROL SYSTEM

(71) Applicant: ANHUI UNIVERSITY OF SCIENCE AND TECHNOLOGY, Huainan (CN)

(72) Inventors: Kun HU, Huainan (CN); Zhuo CHEN, Huainan (CN); Hao JIANG, Huainan (CN); Jie NIU, Huainan (CN); Pengyu WANG, Huainan (CN)

(73) Assignee: ANHUI UNIVERSITY OF SCIENCE AND TECHNOLOGY, Huainan (CN)

(21) Appl. No.: 19/030,942

(22) Filed: Jan. 17, 2025

Related U.S. Application Data
(63) Continuation-in-part of application No. PCT/CN2024/132533, filed on Nov. 18, 2024.

(30) Foreign Application Priority Data
Oct. 8, 2024 (CN) 202411392442.5

(51) Int. Cl. F16C 32/04

(52) U.S. Cl. CPC F16C 32/0478; F16C 2326/58

(57) ABSTRACT

Disclosed is a permanent magnetic levitation buffer roller and a control system. The permanent magnetic levitation buffer roller comprises a roller, a permanent magnetic drum, a magnetic base, a positioner, and a release ring. The permanent magnetic drum is fixedly mounted on two ends of the roller. The roller is located on the magnetic base. The magnetic base is magnetically cooperated with the permanent magnetic drum. One side of the magnetic base away from the roller is fixedly provided with an axial rod. The positioner is slidably mounted on the axial rod. One side of the positioner facing the permanent magnetic drum is uniformly provided with at least one air nozzle. At least one release groove is circumferentially disposed on an edge of the release ring. The control system comprises the permanent magnetic levitation buffer roller, a monitoring device, and a control device.

### TECHNICAL FIELD

This application is a continuation-in-part of International Patent Application No. PCT/CN2024/132533, filed on Nov. 18, 2024, which claims priority to Chinese Patent Application No. 202411392442.5, filed on Oct. 8, 2024, the entire contents of each of which are incorporated herein by reference.

### TECHNICAL FIELD

The present disclosure relates to the field of magnetic levitation rollers, and in particular to a permanent magnetic levitation buffer roller and a control system.

### BACKGROUND

As a form of material transportation, the buffer roller using the magnetic levitation effect has the characteristics of light weight, small rotational inertia, or the like. The magnetic levitation buffer roller is often mounted under the receiving section of the conveyor, so as to reduce the impact of the material on the conveyor belt during blanking and extend the service life of the conveyor belt. Meanwhile, the magnetic levitation buffer rollers also have the characteristics of reducing the mechanical friction during material transportation, lowering the loss of kinetic energy, and enhancing the transportation capacity of the conveyor. In addition, the roller body and seals are made of polymer materials, which have strong corrosion resistance, such that the service life can be far more than those of ordinary rollers in a corrosive occasion.

In the process of material transportation using the magnetic levitation buffer roller, it is necessary to consider how to limit the axial or radial position of the buffer roller in time in the levitated state in the event of voltage imbalance or power failure caused by an unexpected situation, to avoid tipping over or spilling of materials during transportation. In addition, with the changes in the material stacking mode, the rotation state of the roller needs to be controlled in real time to reduce the magnetic attraction effect at the edge and improve the levitation stability. Furthermore, the negative interference caused by an external environment (e.g., dust at the blanking point) is also the main cause of the operation jam of the buffer roller in the magnetic levitation region, which needs to be prevented to improve the interference resistance of the buffer roller.

Therefore, the present disclosure provides a permanent magnetic levitation buffer roller to solve the above technical problems.

### SUMMARY

One or more embodiments of the present disclosure provide a permanent magnetic levitation buffer roller. The permanent magnetic levitation buffer roller may comprise a roller, a permanent magnetic drum, a magnetic base, a positioner, and a release ring. The permanent magnetic drum may be fixedly mounted on two ends of the roller. The roller may be located on the magnetic base. The magnetic base may be magnetically cooperated with the permanent magnetic drum. A conveyor belt may be sleeved in the middle of the roller. The positioner may have a silo structure. The positioner and the permanent magnetic drum may be coaxially arranged. The positioner may be slidably mounted on the magnetic base. One side of the magnetic base away from the roller may be fixedly provided with an axial rod. The positioner may be slidably mounted on the axial rod. One side of the positioner facing the permanent magnetic drum may be uniformly provided with at least one air nozzle. The release ring may be fixedly mounted on an end portion of the permanent magnetic drum. At least one release groove may be circumferentially disposed on an edge of the release ring. Each of the at least one air nozzle may correspond to each of the at least one release groove. The at least one release groove may gradually contract in a direction toward an outer side of the release ring.

One or more embodiments of the present disclosure provide a control system of a permanent magnetic levitation buffer roller. The control system may comprise the permanent magnetic levitation buffer roller, a monitoring device, and a control device. The permanent magnetic levitation buffer roller may include a roller, a permanent magnetic drum, a magnetic base, a positioner, and a release ring. The permanent magnetic drum may be fixedly mounted on two ends of the roller. The roller may be located on the magnetic base. The magnetic base may be magnetically cooperated with the permanent magnetic drum. A conveyor belt may be sleeved in the middle of the roller. The positioner may have a silo structure. The positioner and the permanent magnetic drum may be coaxially arranged. The positioner may be slidably mounted on the magnetic base. One side of the magnetic base away from the roller may be fixedly provided with an axial rod. The positioner may be slidably mounted on the axial rod.

One side of the positioner facing the permanent magnetic drum may be uniformly provided with at least one air nozzle. The release ring may be fixedly mounted on an end portion of the permanent magnetic drum. At least one release groove may be circumferentially disposed on an edge of the release ring. Each of the at least one air nozzle may correspond to each of the at least one release groove. The at least one release groove may gradually contract in a direction toward an outer side of the release ring. The monitoring device may be disposed on the permanent magnetic levitation buffer roller and configured to collect transportation state information of the permanent magnetic levitation buffer roller and send the transportation state information to the control device. The control device may include a first processing device and a second processing device. The first processing device may be configured to determine a blowing parameter based on the transportation state information, and control an external air source connected with the at least one air nozzle of the permanent magnetic levitation buffer roller to blow air to the roller based on the blowing parameter. The second processing device may be configured to determine a rotation parameter based on the transportation state information, and control a motor of the permanent magnetic levitation buffer roller to rotate based on the rotation parameter.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an overall connection structure of a permanent magnetic levitation buffer roller according to some embodiments of the present disclosure;

FIG. 2 is a schematic diagram illustrating a position relationship between a positioner and a permanent magnetic drum according to some embodiments of the present disclosure;

FIG. 3 is a schematic diagram illustrating a cross-sectional view of a local structure of a positioner according to some embodiments of the present disclosure;

FIG. 4 is a schematic diagram illustrating an enlargement of a local structure at B in FIG. 3 according to some embodiments of the present disclosure;

FIG. 5 is a schematic diagram illustrating a cross-sectional view of a local structure of a magnetic base according to some embodiments of the present disclosure;

FIG. 6 is a schematic diagram illustrating an enlargement of a local structure at D in FIG. 5 according to some embodiments of the present disclosure;

FIG. 7 is a schematic diagram illustrating an enlargement of a local structure at E in FIG. 5 according to some embodiments of the present disclosure;

FIG. 8 is a schematic diagram illustrating an enlargement of a local structure at F in FIG. 5 according to some embodiments of the present disclosure;

FIG. 9 is a schematic diagram illustrating a distribution of a light sensor and a light source emitter according to some embodiments of the present disclosure;

FIG. 10 is a schematic diagram illustrating a first position relationship between permanent magnetic shafts and a permanent magnetic drum according to some embodiments of the present disclosure;

FIG. 11 is a schematic diagram illustrating an enlargement of a local structure at A in FIG. 10 according to some embodiments of the present disclosure;

FIG. 12 is a schematic diagram illustrating a second position relationship between permanent magnetic shafts and a permanent magnetic drum according to some embodiments of the present disclosure;

FIG. 13 is a schematic diagram illustrating an enlargement of a local structure at C in FIG. 12 according to some embodiments of the present disclosure;

FIG. 14 is a schematic diagram illustrating an application scenario of a control device and a monitoring device according to some embodiments of the present disclosure;

FIG. 15 is a schematic diagram illustrating a distribution of pressure sensors on a roller according to some embodiments of the present disclosure;

FIG. 16 is a schematic diagram illustrating an exemplary prediction model according to some embodiments of the present disclosure; and

FIG. 17 is a schematic diagram illustrating an exemplary stability model according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system”, “device”, “unit” and/or “module” used herein are a way to distinguish between different components, elements, parts, sections, or assemblies at different levels. However, the terms may be replaced by other expressions if other words accomplish the same purpose.

As shown in the present disclosure and in the claims, unless the context clearly suggests an exception, the words “one”, “a”, “an”, “one kind”, and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

The conventional buffer rollers are difficult to cope with changes in an external environment or an unexpected circumstance, and the adaptive regulation is poor, which increases the possibility of tipping over and spilling of materials during transportation or operation jam.

Therefore, the present disclosure provides a permanent magnetic levitation buffer roller mounted below a receiving section of a conveyor to reduce the impact of the materials on the conveyor belt during blanking and improve the transportation capacity of the conveyor. Meanwhile, axial and radial limiting structures are provided to avoid tipping over or spilling of the materials during transportation, thereby improving the transportation stability.

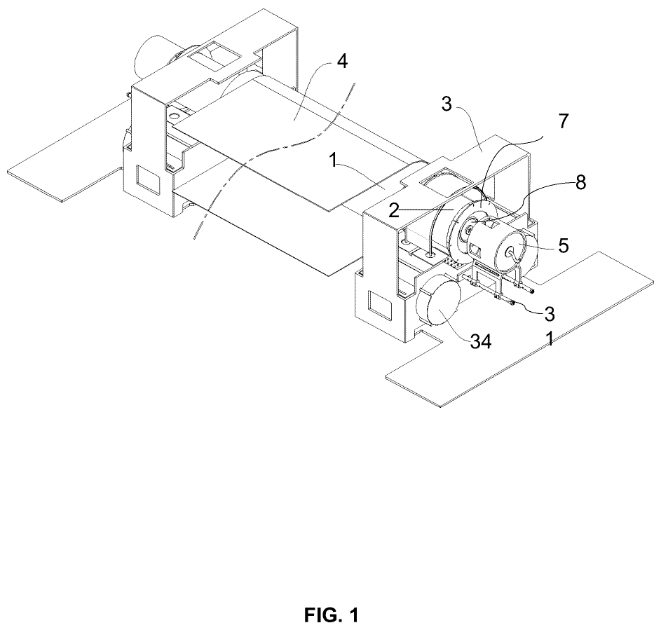

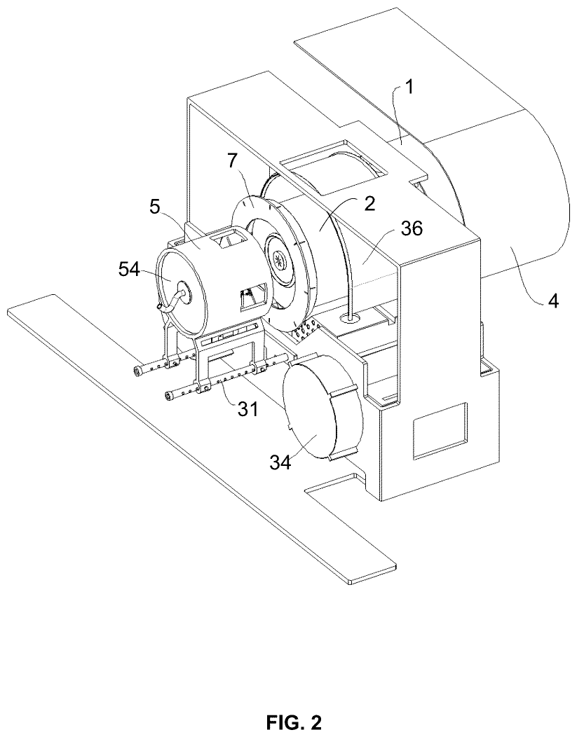

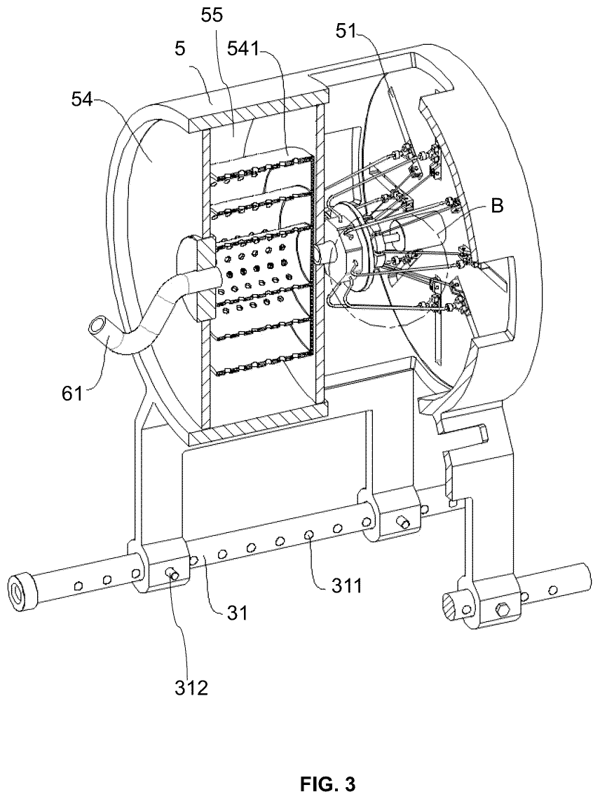

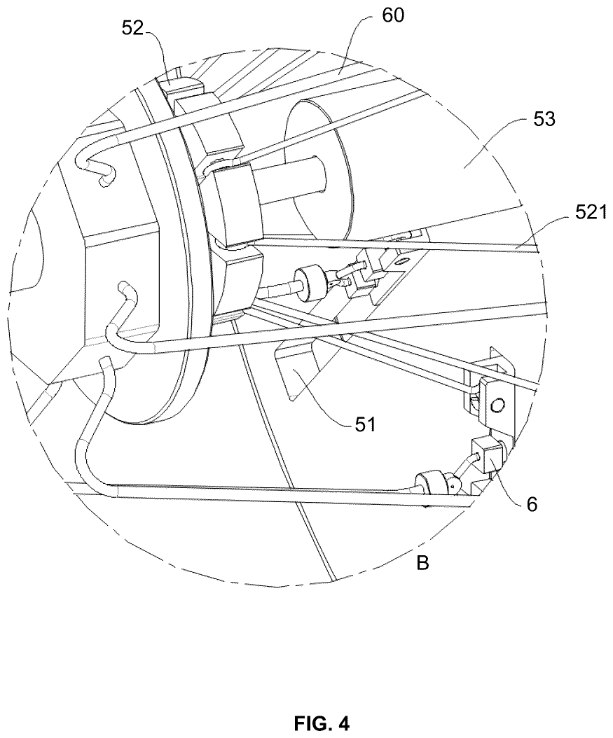

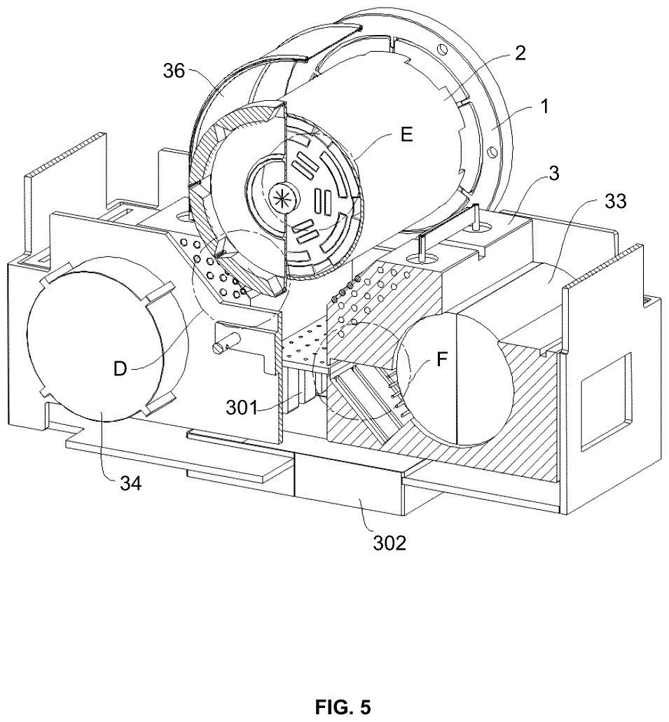

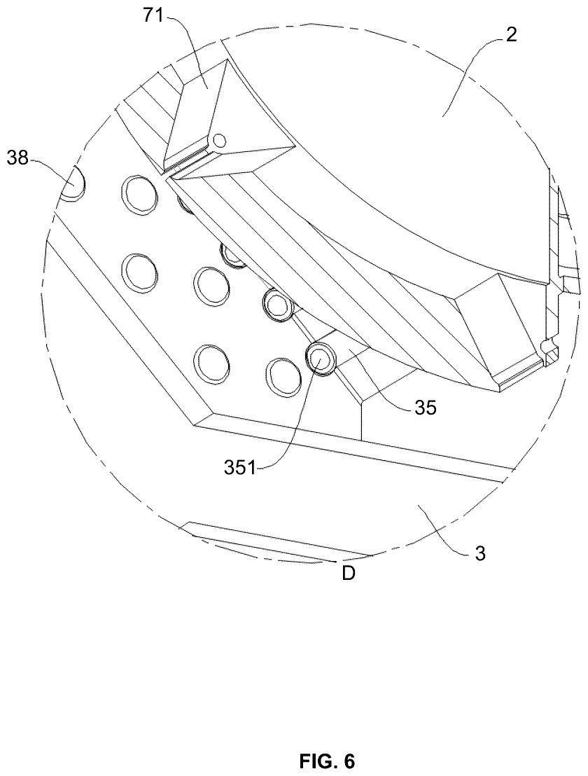

FIG. 1 is a schematic diagram illustrating an overall connection structure of a permanent magnetic levitation buffer roller according to some embodiments of the present disclosure. FIG. 2 is a schematic diagram illustrating a position relationship between a positioner and a permanent magnetic drum according to some embodiments of the present disclosure. FIG. 3 is a schematic diagram illustrating a cross-sectional view of a local structure of a positioner according to some embodiments of the present disclosure. FIG. 4 is a schematic diagram illustrating an enlargement of a local structure at B in FIG. 3 according to some embodiments of the present disclosure. FIG. 5 is a schematic diagram illustrating a cross-sectional view of a local structure of a magnetic base according to some embodiments of the present disclosure. FIG. 6 is a schematic diagram illustrating an enlargement of a local structure at D in FIG. 5 according to some embodiments of the present disclosure.

In some embodiments, as shown in FIGS. 1-6, the permanent magnetic levitation buffer roller may include a roller 1, a permanent magnetic drum 2, a magnetic base 3, a positioner 5, and a release ring 7. The permanent magnetic drum 2 may be fixedly mounted on two ends of the roller 1. The roller 1 may be located on the magnetic base 3. The magnetic base 3 may be magnetically cooperated with the permanent magnetic drum 2. A conveyor belt 4 may be sleeved in the middle of the roller 1. The positioner 5 may have a silo structure. The positioner 5 and the permanent magnetic drum 2 may be coaxially arranged. The positioner 5 may be slidably mounted on the magnetic base 3. One side of the magnetic base 3 away from the roller 1 may be fixedly provided with an axial rod 31. The positioner 5 may be slidably mounted on the axial rod 31. One side of the positioner 5 facing the permanent magnetic drum 2 may be uniformly provided with at least one air nozzle 6. The release ring 7 may be fixedly mounted on an end portion of the permanent magnetic drum 2. At least one release groove 71 may be circumferentially disposed on an edge of the release ring 7. Each of the at least one air nozzle 6 may correspond to each of the at least one release groove 71. The at least one release groove 71 may gradually contract in a direction toward an outer side of the release ring 7.

The roller 1 is a device configured to support a conveyor belt or materials during material transportation.

In some embodiments, the roller 1 may be made of a polymer material. For example, the polymeric material may be selected from at least one of polytetrafluoroethylene, polyamide, or other materials. The mechanical properties of the roller 1 are similar to those of bronze, and the roller 1 has a light specific gravity, good wear resistance, and a self-lubricating property.

The conveyor belt 4 is a conveyor belt configured to convey the materials. The conveyor belt 4 may sleeve the roller 1. When the conveyor belt 4 conveys the materials, the conveyor belt 4 may move to drive the roller 1 to rotate.

The roller 1 is light in weight and has a small rotational inertia. The roller 1 may be mounted under a receiving section of a conveyor to reduce the impact of the materials on the conveyor belt 4 during blanking of the materials, thereby extending the service life of the conveyor belt 4. Meanwhile, the roller 1 may be made of the polymer material, which makes a contact surface friction of the roller 1 and the conveyor belt 4 be small, so as to reduce the damage of the roller 1 to the conveyor belt 4.

The conveyor is a machine configured to convey the materials. The receiving section of the conveyor is a part of the conveyor configured to receive the materials.

The permanent magnetic drum 2 is a device for generating a magnetic field. In some embodiments, the permanent magnetic drum 2 may be coaxially and fixedly connected with the roller 1. For example, as shown in FIGS. 1-2, the permanent magnetic drum 2 may be coaxial with the roller 1 in a horizontal direction, i.e., a central axis of the permanent magnetic drum 2 may coincide with a central axis of the roller 1 in the horizontal direction.

The magnetic base 3 is a structural member for supporting the permanent magnetic drum 2. In some embodiments, the permanent magnetic drum 2 may be disposed on the magnetic base 3. The magnetic base 3 may support the permanent magnetic drum 2 by generating a magnetic field.

In some embodiments, the magnetic base 3 being magnetically cooperated with the permanent magnetic drum 2 means that the magnetic field generated by the permanent magnetic drum 2 and the magnetic field generated by the magnetic base 3 are cooperated with each other to realize levitation of the roller 1. The magnetic field generated by the permanent magnetic drum 2 and the magnetic field generated by the magnetic base 3 being cooperated with each other may include matching in a magnetic field intensity and a magnetic field direction, to make the permanent magnetic drum 2 levitate at a preset position above the magnetic base 3, thereby enabling the levitation of the roller 1 that is fixed to the permanent magnetic drum 2. When the conveyor belt 4 conveys the materials, the roller 1 remain levitated. The preset position may be set according to an actual situation. For example, the preset position may be an upper middle position of the magnetic base 3.

The positioner 5 is a device for maintaining the roller in a correct position during operation. The positioner 5 may prevent tilting or offsetting of the roller 1, ensuring smooth flow of the conveyor belt 4 and the materials.

The positioner 5 and the permanent magnetic drum 2 may be coaxially arranged. For example, as shown in FIG. 2 and FIG. 5, a central axis of the positioner 5 may coincide with a central axis of the permanent magnetic drum 2 in the horizontal direction.

The axial rod 31 is a rod structure for supporting and securing the positioner 5. In some embodiments, as shown in FIGS. 2-3, the axial rod 31 may be disposed along an axial direction of the positioner 5. A central axis of the axial rod 31 may be in the same direction as the central axis of the positioner 5.

The at least one air nozzle 6 refers to a part for air blowing. For example, as shown in FIGS. 3-4, a plurality of air nozzles 6 are uniformly and circumferentially disposed on an end portion of the positioner 5. In some embodiments, the at least one air nozzle may be disposed at two ends of the roller 1, respectively, and also blow air to an end portion sidewall of the permanent magnetic drum 2, so as to enhance the levitation capability of the roller 1.

The release ring 7 is an annular structural member disposed at the end portion of the permanent magnetic drum 2 for releasing airflow. In some embodiments, the release ring 7 may be fixedly mounted on an end portion of a side of the permanent magnetic drum 2 close to the positioner.

The at least one release groove 71 is a groove on the release ring 7 for releasing airflow. The at least one release groove 71 may guide a direction of the airflow. For example, as shown in FIG. 6, the at least one release groove 71 may be a flared groove that gradually contracts in the direction toward the outer side of the release ring 7. The airflow may be released at a mouth of the flared groove.

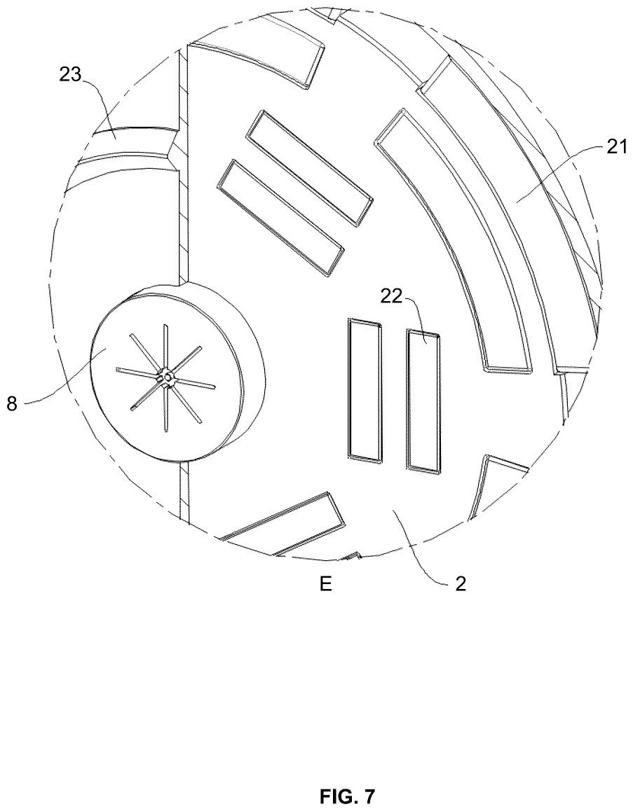

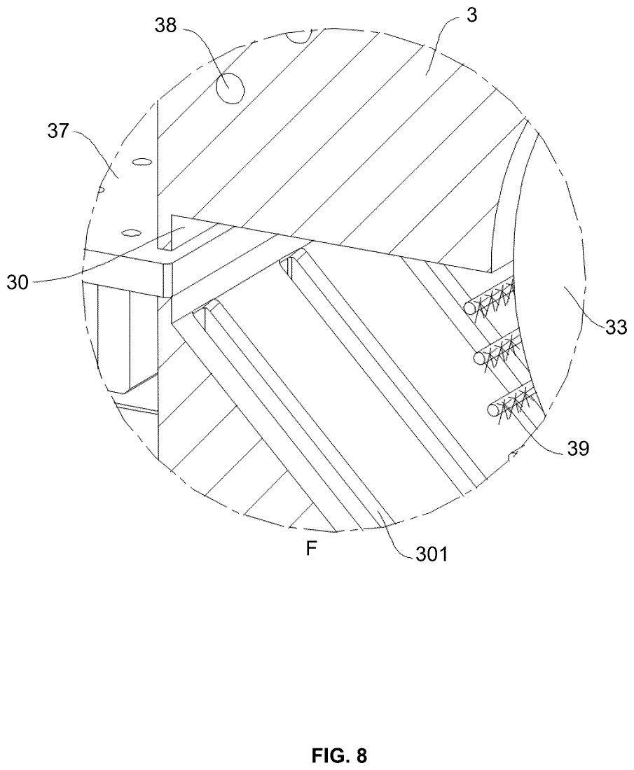

FIG. 7 is a schematic diagram illustrating an enlargement of a local structure at E in FIG. 5 according to some embodiments of the present disclosure. FIG. 8 is a schematic diagram illustrating an enlargement of a local structure at F in FIG. 5 according to some embodiments of the present disclosure.

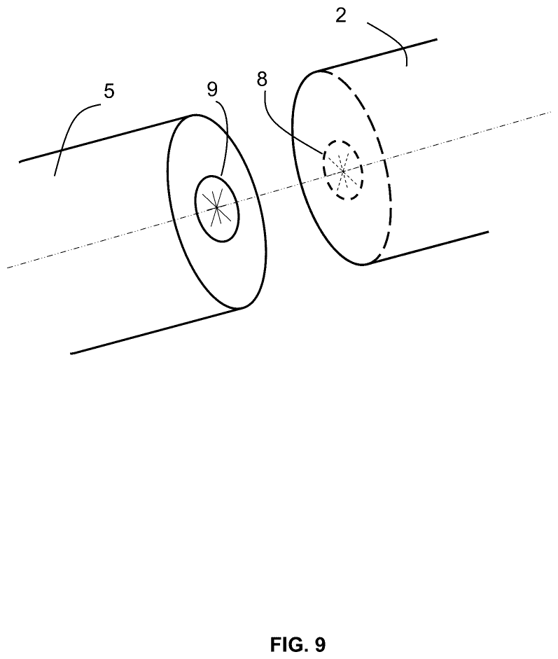

FIG. 9 is a schematic diagram illustrating a distribution of a light sensor and a light source emitter according to some embodiments of the present disclosure.

In some embodiments, as shown in FIG. 5-FIG. 9, the permanent magnetic levitation buffer roller may further include a light sensor 8. The light sensor 8 may be fixedly mounted at a center of an end portion of the permanent magnetic drum 2. A light source emitter 9 cooperated with the light sensor 8 may be fixedly mounted on a side of the positioner 5 facing the permanent magnetic drum 2.

The light sensor 8 is a sensor for detecting changes in light. The light source emitter 9 is a device for emitting light.

The light emitted by the light source emitter 9 may be received by the light sensor 8, and an operation position of the permanent magnetic drum 2 may be auxiliary determined based on a light signal intensity and a position of the light.

For example, as shown in FIG. 9, the light sensor 8 may be fixedly mounted at a center of a side of the permanent magnetic drum 2 facing the positioner 5, and the light source emitter may be fixedly mounted at a center of a side of the positioner 5 facing the permanent magnetic drum 2. In a stable operation state of the roller 1, the light source emitter 9 may exactly face the light sensor 8, i.e., a central axis of the light source emitter 9 may coincide with a central axis of the light sensor 8. In this case, the light sensor 8 may receive a maximum light signal intensity. When the permanent magnetic drum 2 has runaway or deflection in a certain direction under the action of an external impact, the position of the light emitted by the light source emitter changes, and the light signal intensity received by the light sensors 8 is reduced.

In some embodiments, as shown in FIG. 5-FIG. 8, one side of the permanent magnetic drum 2 facing the positioner 5 may be provided with a circumferential separation ring 23. A cross section of the separation ring 23 may be tapered. The separation ring 23 may be disposed at a periphery of the light sensor 8.

The separation ring 23 is an annular structure for separating and blocking the airflow to gather the airflow. In some embodiments, a diameter of the separation ring 23 may be than a diameter of the release ring 7.

The airflow may be separated by the separation ring 23 to make the airflow be gathered in different regions, such that the airflow can realize different action effects. In the stable operation state of the roller 1, the airflow blown from the at least one air nozzle 6 may flow to an outer region of the separation ring 23, and flow along the at least one release groove 71 to an outer side of the release ring 7. When the permanent magnetic drum 2 has runaway or deflection in the certain direction under the action of the external impact, the airflow blown from the at least one air nozzle 6 may mainly flow to an inner side of the separation ring 23 and tend to be concentrated. Under the blocking action of the separation ring 23, the overflow of the airflow from the at least one release groove 71 may be reduced, and the impact of the airflow to the end portion of the permanent magnetic drum 2 may be increased, thereby causing the roller 1 to move in a reverse direction to an initial equilibrium state.

Some embodiments of the present disclosure include, but are not limited to, the following beneficial effects. (1) The arrangement of the roller and the permanent magnetic drum reduces the mechanical friction during material transportation, reduces the loss of kinetic energy, and enhances the transportation capacity of the conveyor. (2) The arrangement of the positioner (including the at least one air nozzle, the axial rod, etc.) can form an axial airflow to limit the roller, so as to avoid tipping over or spilling of the materials during material transportation, and enhance the levitation stability of the roller.

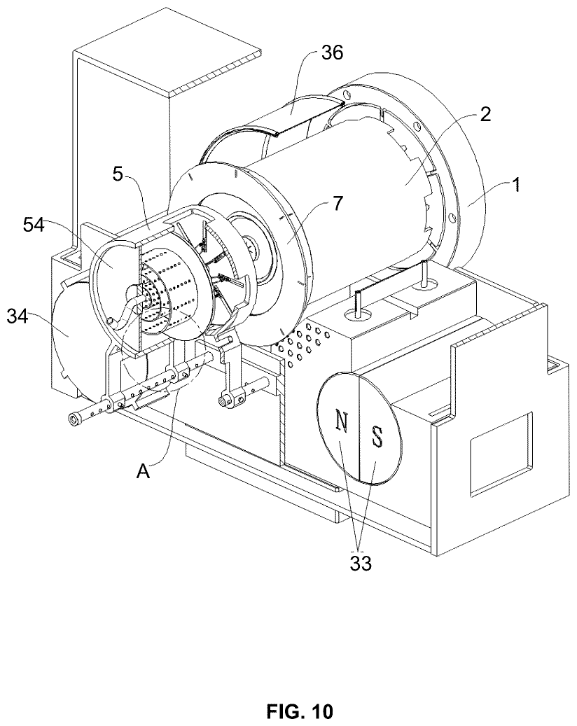

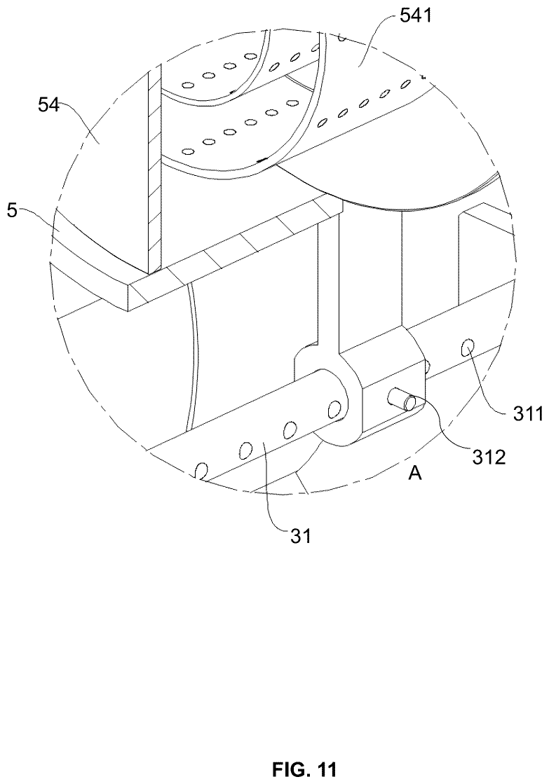

FIG. 10 is a schematic diagram illustrating a first position relationship between permanent magnetic shafts and a permanent magnetic drum according to some embodiments of the present disclosure. FIG. 11 is a schematic diagram illustrating an enlargement of a local structure at A in FIG. 10 according to some embodiments of the present disclosure.

In some embodiments, as shown in FIG. 3, FIG. 10, and FIG. 11, the axial rod 31 may be uniformly provided with pin holes 311 in a direction of a central axis of the axial rod 31, and a bottom of the positioner 5 may be provided with pins 312 matching the pin holes 311.

In some embodiments, the axial rod 31 may be uniformly provided with at least one pin hole 311 along the direction of the central axis of the axial rod 31. The positioner 5 may be slidably provided along the axial rod 31, and the positioner 5 may be secured to different positions of the magnetic base 3 through the pins.

In some embodiments, as shown in FIG. 3 and FIG. 11, the pins 312 may be movably disposed on the bottom of the positioner 5, and the pins 312 may snap fit the pin holes 311. For example, when the pins 312 are withdrawn, the positioner 5 is slidable on the axial rod 31, and when the pins 312 are inserted and the pins 312 snap-fit the pin holes 311, the positioner 5 is fixed.

During operation, with a certain amount of external airflow, the position of the positioner 5 on the axial rod 31 may be adjusted based on the pins 312 and the pin holes 311, so as to make the at least one air nozzle 6 blow air at a position of a preset distance from the end portion of the permanent magnetic drum 2.

In some embodiments, as shown in FIGS. 3-4, at least one positioning groove 51 may be axially provided on a side of the positioner 5 facing the permanent magnetic drum 2. Each of the at least one air nozzle 6 may be slidably mounted in each of the at least one positioning groove 51. A positioning disk 52 may be slidably mounted in the positioner 5. The positioning disk 52 may be hinged with the at least one air nozzle 6 through at least one connecting rod 521. An electric actuator 53 may be fixedly mounted in the positioner 5. One end of the electric actuator 53 may be fixedly connected with the positioning disk 52.

The at least one positioning groove 51 refers to a groove for limiting guidance of the at least one air nozzle 6. The at least one connecting rod 521 is a rod structure for connecting the positioning disk 52 with the at least one air nozzle 6.

In some embodiments, the at least one positioning groove 51, the at least one air nozzle 6, and the at least one connecting rod 521 may correspond to each other.

In some embodiments, the at least one positioning groove 51 may be distributed in a circumferential radial pattern on the side of the positioner 5 toward the permanent magnetic drum 2. In some embodiments, when the positioning disk 52 moves in an axial direction of the positioner 5, the at least one connecting rod 521 may drive the at least one air nozzle 6 to slide back and forth in the at least one positioning groove 51 under the hinged connection.

The electric actuator 53 refers to an electrically powered telescopic actuator. In some embodiments, one end of the electric actuator 53 may be fixedly mounted on the positioner 5, and the other end of the electric actuator 53 may be fixedly mounted on an end portion of the side of the positioner 5 facing the permanent magnetic drum 2. The electric actuator 53 may drive the positioning disk 52 to move along the axial direction of the positioner 5 by expanding and retracting.

During operation, with a certain amount of external airflow, the position of the positioner 5 on the axial rod 31 may be adjusted by the electric actuator 53, and the at least one air nozzle 6 may blow air at the position of the preset distance from the end portion of the permanent magnetic drum 2. The multi-position air nozzles 6 may be disposed in a hinged manner through the at least one connecting rod 521, and when the electric actuator 53 drives the positioning disk 52 to move at a fixed distance, the at least one air nozzle 6 may present a synchronous expansion or contraction state, so as to adjusting the blowing position of the airflow, and enhance the operation stability of the roller 1.

When the permanent magnetic drum 2 has runaway or deflection in a certain direction under the action of an external impact, the electric actuator 53 in a deflection direction of the roller 1 may be activated for positioning, and the positioning disk 52 may be driven to move by the electric actuator 53. The positioning refers to a reverse direction of the deflection direction of the roller 1. In this case, the circumferentially provided at least one air nozzle 6 may gradually move in a contracted state and gradually move to an inner position of the separation ring 23. At this time, the airflow blown out of the at least one air nozzle 6 may mainly flow to the inner side of the separation ring 23 and tend to be concentrated. Under the blocking effect of the separation ring 23, the overflow of the airflow from the at least one release groove 71 may be reduced, and the impact formed by the airflow on the end portion of the permanent magnetic drum 2 may be increased to make the roller 1 to move in the reverse direction and enter an initial equilibrium state. The reverse direction refers to a direction opposite to the deflection direction of the roller 1. In addition, the electric actuator 53 on a side opposite to the deflection direction of the roller 1 may carry out the operation in the reverse direction, such that the airflow at two ends of the roller 1 enters a dynamic equilibrium state, and the return efficiency and accuracy of the roller 1 can be enhanced, thereby enhancing the operation stability and reducing the radial runout of the roller 1.

The arrangement of the positioning disk and the at least one positioning groove may make the effect of axial airflow limiting stable and reliable.

In some embodiments, as shown in FIG. 2 and FIG. 3, one end of the positioner 5 away from the permanent magnetic drum 2 may be provided with a closed cavity 55. An end cap 54 may be fixedly provided at one end of the closed cavity 55 away from the permanent magnetic drum 2. A plurality of filter cartridges 541 may be fixedly mounted in the closed cavity 55.

One end of the positioner 5 away from the permanent magnetic drum 2 may be provided with the closed cavity 55. The plurality of filter cartridges 541 for filtering the airflow may be mounted in the closed cavity 55. The plurality of filter cartridges 541 may be configured to perform drying and purification of the airflow.

The closed cavity 55 is a closed cavity inside the positioner. That is, the end of the positioner 5 away from the permanent magnetic drum 2 may be closed.

The plurality of filter cartridges 541 refer to filtration devices for drying and purifying an airflow. In some embodiments, a plurality of filter cartridges 541 may be fixedly mounted on an inner side of the end cap 54 layer upon layer. A diameter of each of the plurality of filter cartridges 541 may be different. The plurality of filter cartridges 541 may be coaxially arranged. One end of each of the plurality of filter cartridges 541 may be fixedly mounted on the end cap 54. The airflow may first enter a center layer of the plurality of filter cartridges 541, and the airflow may be dried and purified through multi-layer filtration.

In some embodiments, the airflow may enter the closed cavity 55 through an intake pipe 61 to be filtered by the plurality of filter cartridges 541, and then dispensed to the at least one air nozzle 6.

By providing the closed cavity and the filter cartridges, the airflow blown by the positioner 5 through the at least one air nozzle 6 can be clean and even, thereby improving the levitation stability.

A uniform airflow blowing effect may be simultaneously applied to the two ends of the roller 1, which provides the limiting effect in the axial direction while enhancing the levitation capacity of the roller 1, such that the return efficiency and accuracy of the roller 1 can be enhanced, the possibility of runaway or deflection of the roller 1 can be reduced, and the radial runout of the roller 1 can be reduced. Meanwhile, the error correction capability is provided for the unstable operation state of the roller 1, so as to realize the adjustability of the rotation state of the roller 1.

In some embodiments, as shown in FIGS. 3-4, each of the at least one air nozzle 6 may be communicated with the closed cavity 55 of the positioner 5 through a hose 60. The intake pipe 61 may be fixedly mounted on the end cap 54. An inlet end of the intake pipe 61 may be communicated with a central region of each of the plurality of filter cartridges 541.

The hose 60 is a flexible pipe that allows the airflow into the positioner 5. The hose 60 may be made of polyvinyl chloride (PVC), polyurethane (PU), rubber, or other flexible materials.

The intake pipe 61 is a duct that directs an external airflow into the closed cavity 55. In some embodiments, the airflow may enter the central region of each of the plurality of filter cartridges 541 through the intake pipe 61. After being dried and purified by the plurality of filter cartridges 541, the airflow may enter the positioner 5, and then flow to the at least one air nozzle 6 through a plurality of hoses 60, respectively. The airflow may be directionally blown to an end portion sidewall of the permanent magnetic drum 2 through the at least one air nozzle 6.

During operation, the airflow generated by an external air source may enter the closed cavity at the end portion of the positioner 5 through the intake pipe 61; after being dried and purified by the plurality of filter cartridges 541, the airflow may flow into the circumferentially provided at least one air nozzle 6 through the plurality of hoses 60 respectively, and may be directionally blown to the end portion sidewall of the permanent magnetic drum 2 through the at least one air nozzle 6. In this case, the uniform airflow may be simultaneously applied to the two ends of the roller 1, which provides the limiting effect in the axial direction of the roller 1 while enhancing the levitation capacity of the roller 1, thereby reducing the possibility of runaway or deflection of the roller 1.

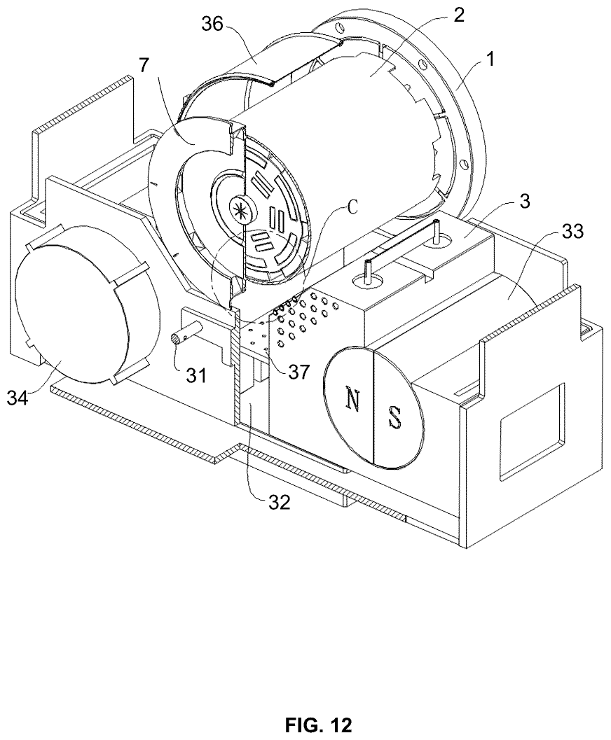

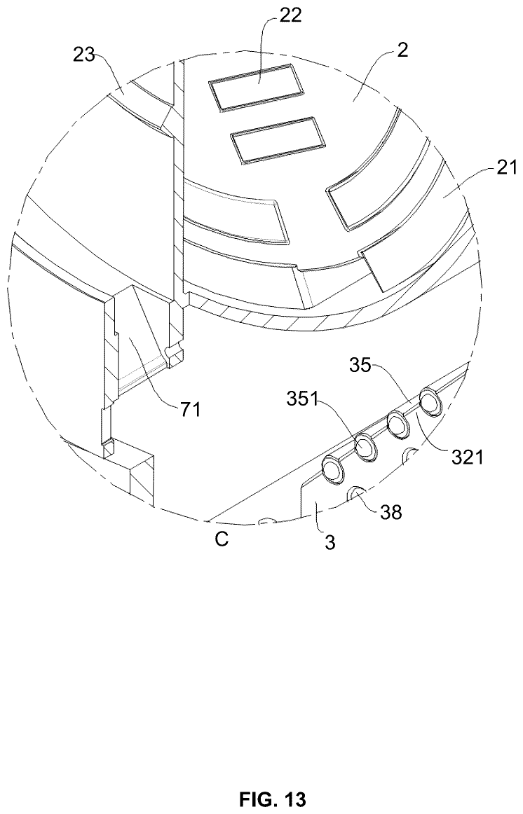

FIG. 12 is a schematic diagram illustrating a second position relationship between permanent magnetic shafts and a permanent magnetic drum according to some embodiments of the present disclosure. FIG. 13 is a schematic diagram illustrating an enlargement of a local structure at C in FIG. 12 according to some embodiments of the present disclosure.

In some embodiments, as shown in FIGS. 12-13, the permanent magnetic drum 2 may include magnetic tiles 21 and permanent magnets 22. The magnetic tiles 21 and the permanent magnets 22 may be staggered inside the permanent magnetic drum 2.

The magnetic tiles 21 are permanent magnets of a specific shape. The magnetic tiles 21 may be in the form of thin sheets or tiles. For example, as shown in FIG. 13, the magnetic tiles 21 may be in the form of tiles.

The permanent magnets 22 are objects that have permanent magnetic characteristics and do not require an external power source or current to maintain a magnetic field. For example, the permanent magnets 22 may include at least one of a neodymium-iron-boron permanent magnet or an aluminum-nickel-cobalt permanent magnet, etc.

In some embodiments, the magnetic tiles 21 and the permanent magnets 22 may be staggered in various ways. For example, the permanent magnetic drum 2 may include at least one circle of circumferentially distributed magnetic tiles 21 and at least one circle of circumferentially distributed permanent magnets 22. Inner diameters of annular structures formed by the magnetic tiles 21 and the permanent magnets 22 may be the same or different. For example, as shown in FIG. 13, the magnetic tiles 21 and the permanent magnets 22 may be staggered around inside the permanent magnetic drum 2 at different radii.

The magnetic tiles 21 and the permanent magnets 22 are staggered, such that the edge magnetic attraction effect can be reduced, and the levitation stability of the magnetic levitation roller can be improved.

In some embodiments, as shown in FIGS. 12-13, a sinking groove 32 communicating vertically may be provided in the middle of the magnetic base 3. The permanent magnetic drum 2 may be located directly above the sinking groove 32. An upper portion of a mouth of the sinking groove 32 may be symmetrically provided with slope structures. Slope surfaces 321 of the slope structures may be parallel to a central axis of the permanent magnetic drum 2.

The sinking groove 32 is a groove running vertically in the middle of the magnetic base 3.

In some embodiments, a width of the sinking groove 32 may be less than an outer diameter of the permanent magnetic drum 2, so as to prevent the permanent magnetic drum 2 from falling into the sinking groove 32 and realizing the limiting effect. The width of the sinking groove 32 is a width of the sinking groove 32 in a direction perpendicular to the central axis of the permanent magnetic drum 2 on a horizontal plane.

The slope structures are inclined structures on an upper portion of the sinking groove 32. Inclination angles of the slope surfaces 321 of the slope structures may be preset based on experience. The inclination angles of the slope surfaces 321 refer to angles between the slope surfaces and a horizontal line. For example, the inclination angles of the slope surfaces 321 may be 30°, 60°, etc.

The sinking groove may be provided, and the slope structures on the upper portion of the sinking groove may be used as the bottom support of the roller, which can enhance the support stability of the magnetic base to the roller. In case of a voltage imbalance or power failure state caused by an unexpected condition, the symmetrically provided slope structures can provide additional auxiliary limiting for the permanent magnetic drum 2.

In some embodiments, permanent magnetic shafts 33 may be rotationally mounted on two sides of the magnetic base 3. The permanent magnetic shafts 33 may be located below the slope structures. The permanent magnetic shafts 33, the magnetic tiles 21, and the permanent magnets 22 may be magnetically cooperated. A motor 34 may be fixedly mounted on one side of the magnetic base 3, and an output shaft of the motor 34 may be fixedly connected with each of the permanent magnetic shafts 33.

The permanent magnetic shafts 33 are components having permanent magnetism. The permanent magnetic shafts 33 may have a regular shape. For example, as shown in FIG. 12, the permanent magnetic shafts 33 may be cylindrical. In some embodiments, the central axes of the permanent magnetic shafts 33 may be parallel to a central axis of the permanent magnetic drum 2.

In some embodiments, the permanent magnetic shafts 33, the magnetic tiles 21, and the permanent magnets 22 being magnetically cooperated means that magnetic fields generated by the permanent magnetic shafts 33, the magnetic tiles 21, and the permanent magnets 22 may be cooperated with each other to make the roller 1 and the permanent magnetic drum 2 levitate. More descriptions regarding cooperation of the magnetic fields may be found in FIGS. 1-6.

The motor 34 refers to a device that provides rotational power to the permanent magnetic shafts 33.

In some embodiments, the output shaft of the motor 34 may be fixedly connected with the permanent magnetic shafts 33 through a threaded connection or a welded connection, etc.

By providing the permanent magnetic shafts 33 and the motor 34, the permanent magnetic shafts 33 can rotate under the action of the motor 34 to change a magnetic circuit of the magnetic base 3, so as to adjust the magnetic field generated by the magnetic base 3. The permanent magnetic shafts 33, the magnetic tiles 21, and the permanent magnets 33 are magnetically cooperated to make the permanent magnetic drum 2 enter a state of stable magnetic levitation rotation, thereby reducing contact friction, and improving the operation stability and the service life of the permanent magnetic drum 2.

In some embodiments, as shown in FIG. 12 and FIG. 13, a plurality of bearing shafts 35 may be rotationally mounted on the slope surfaces 321 of the slope structures. The plurality of bearing shafts 35 may rotationally fit an outer wall of the permanent magnetic drum 2. A ball plunger 351 may be rotationally mounted on one end of each of the bearing shafts 35 close to the release ring 7. An end portion of the ball plunger 351 may fit an outer wall of the release ring 7 in a rolling manner.

The plurality of bearing shafts 35 are rollable shafts for bearing the permanent magnetic drum 2. In some embodiments, the plurality of bearing shafts 35 may be mounted on and partially protrude from the slope surfaces 321 of the slope structures.

The ball plunger 351 is a mechanical component that has a spherical top and is rollable. The ball plunger 351 is rollable relative to the plurality of bearing shafts 35.

When the roller 1 enters the stable rotating state, the rotating release ring 7 may be close to but not contact with the ball plunger 351. When the roller 1 has a special unstable operation state (e.g., runaway or imbalance), the rotating release ring 7 may be gradually close to and contact with the ball plunger 351. A runaway amplitude of the roller 1 to the two ends may be reduced by the limiting and abutting effect of the inner side of the ball plunger 351, which improves the rotation stability of the roller 1, and reduces the possibility of tipping over or spilling of the materials during transportation.

The additional auxiliary limiting may be provided for the permanent magnetic drum 2 by setting the bearing shafts rotationally fitting the outer wall of the permanent magnetic drum 2, so as to avoid direct contact between the permanent magnetic drum 2 and the slope surfaces 321. The rolling friction is used instead of the sliding friction, which improves the operation stability and the service life of the permanent magnetic drum 2. Meanwhile, during the rotation of the roller 1, the axial limiting ability of the magnetic base on the roller 1 may be enhanced by the ball plunger 351 cooperating with the release ring 7.

In some embodiments, as shown in FIGS. 2-12, a shield ring 36 may be fixedly mounted on an upper portion of the magnetic base 3. The shield ring 36 may surround a periphery of the permanent magnetic drum 2. A cotton plate 37 may be movably mounted below the slope structures. The cotton plate 37 may be located below the shield ring 36.

The shield ring 36 is an annular component that prevents foreign objects from entering a magnetic levitation region.

The cotton plate 37 is a panel component for dustproofing and breathability. In some embodiments, the cotton plate 37 may be a breathable cotton plate. The breathable cotton plate may be made of a breathable cotton material.

The airflow overflowing from the position of the at least one release groove 71 may be partially blown to an inner side of the shield ring 36 in the axial direction of the permanent magnetic drum 2. After the airflow passing through an annular region below the shield ring 36, a flow direction and a flow velocity of the airflow may be secondarily centralized, and the airflow may carry adhesive residual dust away in a direction that fits an outer contour of the permanent magnetic drum 2. When the airflow passes through the cotton plate 37 disposed below the slope structures of the magnetic base 3, the cotton plate 37 may trap and collect the dust mixed in the airflow, so as to reduce a dust dispersion region.

During daily operation, the shield ring 36 not only provides physical protection for the permanent magnetic drum 2 to prevent external objects from directly contacting or damaging the permanent magnetic drum 2, but also helps to shield the permanent magnetic drum 2 from falling dust above the permanent magnetic drum 2. For example, the shield ring 36 can prevent dust at the position of a blanking point from entering the magnetic levitation region to cause the operation jam, thereby enhancing the cleanliness of the outer wall of the permanent magnetic drum 2, reducing the negative impact of the dust on the magnetic levitation effect, and enhancing the anti-interference ability of the roller 1.

In some embodiments, as shown in FIG. 8, evacuation holes 38 may be uniformly disposed on one side of the magnetic base 3 facing the positioner 5. A wiping cavity 30 may be disposed on an inner side of the magnetic base 3. A plurality of wiping rods 39 may be fixedly mounted in the wiping cavity 30. The plurality of wiping rods 39 may be arranged around the permanent magnetic shafts 33. An end portion of each of the evacuation holes 38 may be communicated with the wiping cavity 30.

The evacuation holes 38 are holes in the magnetic base 3 for evacuating excess airflow.

The wiping cavity 30 is a cavity for wiping the permanent magnetic shafts 33 and allowing the airflow to flow. In some embodiments, the end portion of each of the evacuation holes 38 may be communicated with the wiping cavity 30. The airflow may enter the wiping cavity 30 through the evacuation holes 38 to form the airflow.

The plurality of wiping rods 39 are rod components for wiping the permanent magnetic shafts 33. In some embodiments, the plurality of wiping rods 39 may remove dust and contaminants from outer walls of the permanent magnetic shafts 33 by contact as the permanent magnetic shafts 33 rotate.

Providing the wiping cavity 30 and the plurality of wiping rods 39 can remove dust and impurities from the outside world during operation of the permanent magnetic shafts, so as to avoid jamming during rotation of the permanent magnetic shafts 33.

In some embodiments, as shown in FIG. 5 and FIG. 8, a waste chip chute 301 and a waste chip box 302 may be disposed at a bottom of the magnetic base 3. The waste chip chute 301 may be communicated with the wiping cavity 30. The waste chip box 302 may be located below the waste chip chute 301.

The waste chip chute 301 is a slot for guiding waste chips in the wiping cavity 30 through. The waste chips may include dust, impurities, or the like. In some embodiments, as shown in FIG. 8, a plurality of waste chip chutes 301 communicated with the wiping cavity 30 may be uniformly disposed at the bottom of the magnetic base 3.

The waste chip box 302 is a component for collecting and storing the waste chips. The waste chips in the wiping cavity 30 may enter the bottom of the magnetic base through the waste chip chute 301 and finally collected in the waste chip box 302.

In some embodiments, the waste chip box 302 may be movably mounted to the magnetic base 3 below the waste chip chute 301. When the waste chip box 302 is full, the waste chip box 302 may be taken out and cleaned in time.

By providing the waste chip chute 301 and the waste chip box 302, the waste chips in the wiping cavity 30 can be guided and collected, which avoids the waste chips remaining in the wiping cavity 30, so as to avoid affecting the normal operation of the permanent magnetic shafts 33.

In some embodiments, as shown in FIG. 5, FIG. 12, and FIG. 13, the at least one release groove 71 may be disposed on an outer side of the evacuation holes 38, a through hole pointing to the evacuation holes 38 may be disposed at a bottom of the at least one release groove 71, and the cotton plate 37 may be disposed between the evacuation holes 38 and the waste chip chute 301.

Part of the airflow from the at least one release groove 71 may enter the wiping cavity 30 through the evacuation holes 38, and flow out from the waste chip chute 301. Meanwhile, a negative pressure may be formed in the wiping cavity 30. With the plurality of wiping rods 39 wiping and cleaning the outer wall of the permanent magnetic shafts 33, the residual dust adhered to the outer wall of the permanent magnetic shafts 33 may be guided to the waste chip chute 301 and finally discharged to be collected in the waste chip box 302. The levitation stability of the roller 1 is enhanced by using the airflow, and the dust of the magnetic effect region is guided to be cleaned and collected by using the discharge process of the airflow, so as to enhance the cleanliness of the magnetic levitation region and the interference ability of the roller 1.

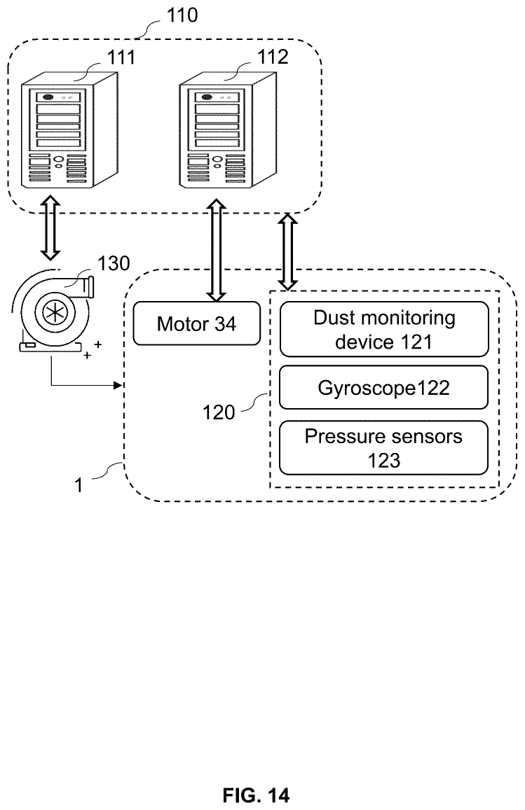

FIG. 14 is a schematic diagram illustrating an application scenario of a control device and a monitoring device according to some embodiments of the present disclosure.

In some embodiments, as shown in FIG. 14, a permanent magnetic levitation buffer roller may be controlled by a control device 110. The control device 110 may include a first processing device 111 and a second processing device 112. The first processing device 111 may be configured to control an external air source 130 connected with the at least one air nozzle 6 of the permanent magnetic levitation buffer roller to blow air to the roller 1 based on a blowing parameter. The second processing device 112 may be configured to control a motor 34 of the permanent magnetic levitation buffer roller to rotate based on a rotation parameter.

The control device 110 is a device for controlling various parts of the permanent magnetic levitation buffer roller to realize a magnetic levitation function. The first processing device 111 is a device for processing parameters related to the blowing process. The second processing device 112 is a device for processing parameters related to the rotation of the permanent magnetic levitation buffer roller.

In some embodiments, the first processing device 111 may include a processing device in communication connection with the external air source, such as a processor, a server, a computer, or the like. The external air source is an external device for providing an airflow. For example, the external air source may be at least one of an air compressor, a fan or blower, a pneumatic valve, or the like.

In some embodiments, the second processing device 112 may include a processing device in communication connection with the motor 34 of the permanent magnetic levitation buffer roller, such as a processor, a server, a computer, or the like.

In some embodiments, the first processing device 111 and the second processing device 112 may be the same processing device or may be two different processing devices.

The blowing parameter is a parameter related to the airflow provided by the external air source. For example, the blowing parameter may include a blowing time period, an airflow velocity, an airflow pressure, or the like. The blowing parameter of the external air source at two ends of the roller 1 may be consistent.

In some embodiments, the blowing parameter may be determined based on transportation state information of the permanent magnetic levitation buffer roller. More descriptions may be found in the present disclosure below.

The rotation parameter is a parameter related to the rotation of the motor 34. For example, the rotation parameter may include a rotation angle, a rotation velocity, or the like, of the motor 34. By the rotation of the permanent magnetic shafts 33, a direction of a magnetic field generated by the permanent magnetic shafts 33 changes, a magnetic flux in a vertical direction changes, and a magnetic force to the roller 1 changes. The greater the magnetic force, the more stable the roller 1.

In some embodiments, the rotation parameter may be determined based on transportation state information of the permanent magnetic levitation buffer roller. The transportation state information may be collected by a monitoring device 120. The transportation state information may include a dust concentration, pressure data, and motion information.

The transportation state information reflects information related to an operation state of the permanent magnetic levitation buffer roller during material transportation. The dust concentration reflects a concentration of dust in an environment where the permanent magnetic levitation buffer roller is located. The pressure data reflects the pressure to the roller 1 during material transportation. The motion information reflects the motion of the roller 1 during material transportation.

The monitoring device 120 is a device for monitoring the transportation state information. In some embodiments, as shown in FIG. 14, the monitoring device 120 may be in communication connection with the control device 110. The monitoring device 120 may send the collected transportation state information to control device 110.

In some embodiments, as shown in FIG. 14, the monitoring device may include a dust monitoring device 121, a gyroscope 122, and a plurality of pressure sensors 123. The dust monitoring device 121 may be configured to collect the dust concentration in real time. The gyroscope 122 may be disposed in the roller 1 and configured to monitor the motion information. The plurality of pressure sensors 123 may be disposed on an outer surface of the roller 1 and configured to collect the pressure data.

In some embodiments, the dust monitoring device 121 may be a dust detector, such as a laser dust meter, an online continuous dust meter, or the like. The dust monitoring device 121 may collect the dust concentration at a preset frequency. The preset frequency may be preset based on experience.

In some embodiments, the dust monitoring device 121 may be disposed at a preset position of the permanent magnetic levitation buffer roller. The preset position may be determined based on experience. The dust monitoring device 121 may be disposed at a position susceptible to dust. For example, the preset position may include an interior of the roller 1, a position where the at least one air nozzle 6 is located, or the like.

In some embodiments, the gyroscope 122 may be fixedly disposed at an arbitrary point within the roller 1. The motion information may include a motion trajectory of a point where the gyroscope 122 is located in space.

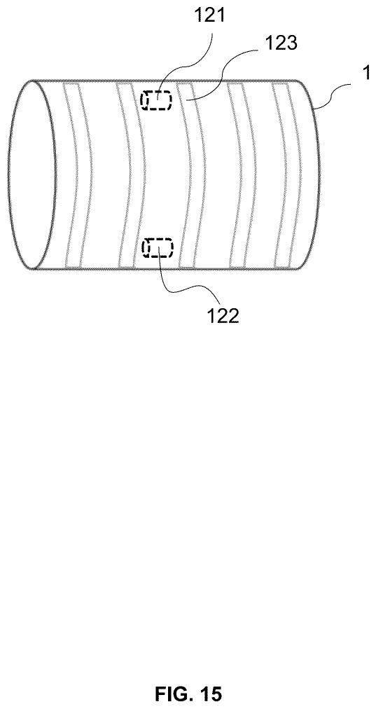

FIG. 15 is a schematic diagram illustrating a distribution of pressure sensors on a roller according to some embodiments of the present disclosure.

In some embodiments, as shown in FIG. 15, the plurality of pressure sensors 123 may be disposed in an annular pattern at a plurality of positions of the roller 1. A spacing distance between the adjacent pressure sensors 123 of the plurality of pressure sensors 123 may be set according to the demand. The smaller the spacing distance, the more accurate the measured pressure data.

In some embodiments, the first processing device 111 may be configured to determine a blowing parameter of an external air source based on a dust concentration.

In some embodiments, the first processing device 111 may determine the blowing parameter based on the dust concentration and a preset concentration threshold. For example, the first processing device 111 may calculate a concentration difference between the dust concentration and the preset concentration threshold. In response to determining that the concentration difference is less than or equal to 0, the first processing device 111 may determine the blowing parameter to be 0, i.e., no blowing. In response to determining that the concentration difference is greater than 0, the first processing device 111 may search a first parameter table to determine the blowing parameter.

The preset concentration threshold is a critical value of the dust concentration for determining whether blowing is required. The preset concentration threshold may be set based on experience or demand. The concentration difference is a value difference between the dust concentration and the preset concentration threshold.

The first parameter table may include blowing parameters corresponding to different concentration differences. The first parameter table may be set based on experience or historical data. For example, for a given concentration difference, a historical airflow velocity, a historical airflow pressure, and a historical blowing time period in the historical data where the dust concentration decreases the fastest and the transportation is the smoothest after blowing may be determined as the blowing parameters corresponding to the given concentration difference.

The historical airflow velocity, the historical airflow pressure, and the historical blowing time period are an airflow velocity, an airflow pressure, and a blowing time period of the external air source during a historical blowing process.

The dust content is monitored in real time through the dust monitoring device, and the blowing parameter is determined according to the dust content, which can clean up the dust in time, and reduce the impact on the roller 1.

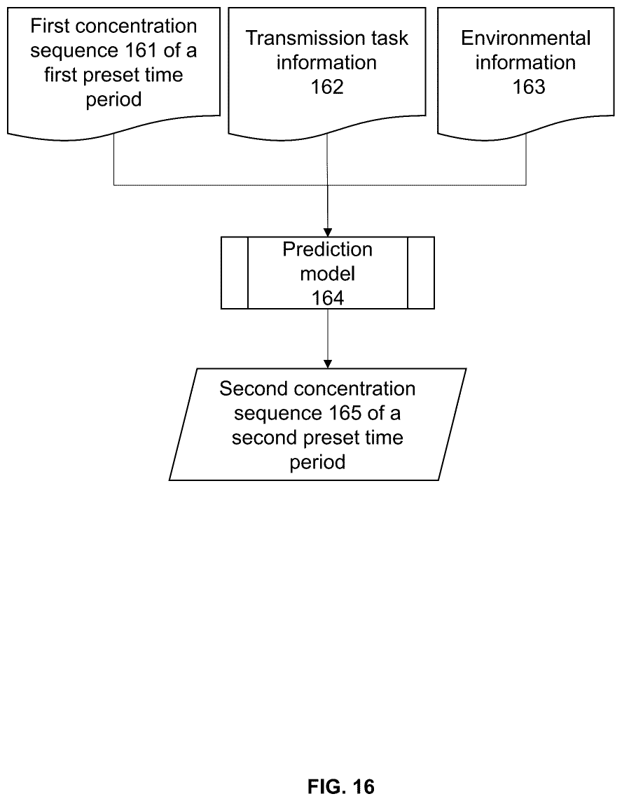

FIG. 16 is a schematic diagram illustrating an exemplary prediction model according to some embodiments of the present disclosure.

In some embodiments, as shown in FIG. 16, the first processing device 111 may be configured to predict a second concentration sequence 165 of a second preset time period through a prediction model 164 based on a first concentration sequence 161 of a first preset time period, transmission task information 162, and environmental information 163, the prediction model being a machine learning model; and determine a blowing parameter based on the second concentration sequence.

The first preset time period refers to the current time period. A duration of the first preset time period may be set according to demand. For example, the first preset time period is the current 1 hour. The first concentration sequence 161 is a sequence obtained by arranging dust concentrations collected at a plurality of consecutive moments according to collection time within the first preset time period.

The second preset time period is a future time period corresponding to the first preset time period. A duration of the second preset time period may be the same as that of the first preset time period. For example, the current moment is 9:00, the first preset time period is 8:00-9:00 today, and the second preset time period is 8:00-9:00 tomorrow. The second concentration sequence 165 is a sequence obtained by arranging predicted dust concentrations at a plurality of consecutive moments in a chronological order within the second preset time period.

The transmission task information is information related to transported materials. For example, the transmission task information may include a type of the transported materials, a weight of the transported materials, or the like. The first processing device 111 may obtain the transmission task information uploaded by a user via a user terminal.

The environmental information reflects information related to an environment wherein the permanent magnetic levitation buffer roller is located, such as an ambient temperature, a humidity, or the like. The first processing device 111 may obtain the environmental information 163 through a temperature sensor, a humidity sensor, etc.

The prediction model 164 is a model for predicting the second concentration sequence 165 of the second preset time period. In some embodiments, the prediction model 164 may be a recurrent neural network (RNN) model. An input of the prediction model 164 may include the first concentration sequence 161 of the first preset time period, the transmission task information 162, and the environmental information 163, and an output of the prediction model 164 may include the second concentration sequence 165 of the second preset time period.

In some embodiments, the prediction model 164 may be obtained by training a large number of first training samples and first labels corresponding to the first training samples. For example, the first processing device 111 may build a training dataset based on the large number of the first training samples and the first labels corresponding to the first training samples, and perform multiple iterations based on the training dataset; and when an iteration condition is satisfied, end the iteration to obtain a trained prediction model. At least one of the multiple of iterations may include: selecting one or more first training samples from the training dataset to input into the prediction model to obtain one or more outputs of the prediction model corresponding to the first training samples; substituting the outputs of the prediction model and the first labels into a predefined formula of a loss function to calculate a value of the loss function; and inversely updating a model parameter of the prediction model through a preset update method. The preset update method may be a gradient descent method, etc. The iteration condition may be that the loss function converges, a count of iterations reaches a threshold, etc.

Each set of the first training samples may include a sample first concentration sequence, sample transmission task information, and sample environmental information. The first training samples may be obtained by collecting sample data. The sample data may include a sequence consisting of sample dust concentrations collected at a plurality of consecutive moments within a first time period during transportation of the roller, the sample transfer task information, and the sample environmental information. The first labels may include a sequence consisting of sample dust concentrations actually collected at a plurality of consecutive moments within a second time period. The second time period may be later than the first time period. A duration of the second time period may be the same with a duration of the first time period.

In some embodiments, the first processing device 111 may determine whether a dust concentration greater than the preset concentration threshold exists in the second concentration sequence; in response to that the dust concentration greater than the preset concentration threshold exists in the second concentration sequence, take a preset time period before the dust concentration reaches the concentration threshold as a blowing time period of an external air source, and take a minimum airflow velocity and a minimum airflow pressure in the first parameter table as an airflow velocity and an airflow pressure of the external air source.

The preset time period may be determined in various ways. For example, the preset time period may be preset based on experience, such as 3 minutes prior to reaching the preset concentration threshold. As another example, the preset time period may be correlated with a future dust increase rate. The first processing device 111 may calculate a statistical value of the dust concentration increase rate as a future dust increase rate based on the second concentration sequence. The statistical value may be an average of increase rates of a plurality of adjacent dust concentrations in the second concentration sequence. The statistic value may also be an increase rate of the last dust concentration in the second concentration sequence relative to a first dust concentration. The faster the future dust increase rate, the earlier the preset time period.

The airflow may be introduced in advance, which ensures that the dust concentration does not exceed the preset concentration threshold. In addition, the airflow may be introduced in advance at a minimal airflow to minimize the impact on the roller 1 when the external air source blows to the roller 1.

In some embodiments, the first processing device 111 may be configured to determine current jitter data based on the motion information; and determine the blowing parameter through historical blowing record based on the current jitter data and the transmission task information.

More descriptions regarding the motion information, the transmission task information, and the blowing parameter may be found in FIG. 14 and the related descriptions thereof.

The current jitter data is data reflecting a current jitter condition of the roller 1. The current jitter data may include an axial jitter distance, an axial jitter frequency, a radial jitter distance, and a radial jitter frequency of the roller 1 at the current moment. Under normal circumstances, the rotation of the roller 1 is smooth. When the external air source blows air to the roller 1, the rotation of the roller 1 may cause some jitter due to the impact of the airflow.

In some embodiments, the gyroscope 122 may be configured to measure a motion trajectory at a point where the gyroscope 122 is located at the current time period and send the motion trajectory to the first processing device 111. The first processing device 111 may determine the jitter data by comparing the motion trajectory with a standard motion trajectory. The standard motion trajectory is a motion trajectory of the gyroscope 122 without any jitter.

The historical blowing record is a data record of a historical blowing process. The historical blowing record may include historical transmission task information, a historical blowing parameter, first jitter data, and second jitter data. The first jitter data is historical jitter data before the blowing. The second jitter data is historical jitter data after the blow.

In some embodiments, the first processing device 111 may construct a feature vector based on the transmission task information and the current jitter data, and retrieve at least one reference vector with the highest similarity to the feature vector in a vector database of the historical blowing record; and select a historical blowing parameter corresponding to the smallest second jitter data as the blowing parameter of the external air source in a historical blowing record corresponding to the at least one reference vector. The reference vector may be constructed based on the historical transmission task information and the first jitter data.

The blowing parameter may be determined based on the current jitter data and the historical blowing record, which ensures that the jitter occurring to the roller 1 is small when the external air source blows air, thereby reducing the impact on the roller.

In some embodiments, the first processing device 111 may be further configured to obtain pressure data based on pressure sensors; determine material drop data based on the pressure data; and determine a blowing parameter of two ends of the roller based on material drop data and the dust concentration.

The material drop data is data that reflects a material drop condition. The material drop data may include a material drop position, an impact force, etc. In an ideal condition, the material drop position is in the center of the roller. In an actuation condition, the material drop position may be shifted.

In some embodiments, the first processing device 111 may be configured to obtain pressure data of a plurality of sensors at a plurality of moments based on the pressure sensors and plot a pressure change curve; take a moment of sudden increase in pressure in the pressure change curve as a material drop moment; and take a maximum pressure among the pressure data of the plurality of sensors at the drop moment as the impact force, and take a position of the sensor at which the maximum pressure is measured as the material drop position.

In some embodiments, the first processing device 111 may fit a pressure curve based on the pressure data of the plurality of sensors at the plurality of moments, and take a position corresponding to a point of maximum value in the pressure curve as the drop position, and the maximum value as the value of the impact force.

In some embodiments, the first processing device 111 may query a first parameter table based on a concentration difference between the dust concentration and the preset concentration threshold, and take the obtained blowing parameter as an initial blowing parameter. More descriptions regarding the first parameter table may be found in FIG. 14 and the related descriptions thereof.

In some embodiments, the first processing device 111 may obtain the blowing parameter of the two ends of the roller 1 based on the material drop location and the initial blowing parameter. For example, the processor may calculate a distance from the drop position to the two ends of the roller 1, increase an airflow velocity and an airflow pressure corresponding to an end with the smaller distance, and decrease an airflow velocity and an airflow pressure corresponding to the other end of the two ends by an equal amount. The larger the difference in the distance from the drop position to the ends of the roller 1, the larger the adjustment magnitude of the airflow velocity and the airflow pressure.

When the material drop point is not centered, the roller may be assisted to regain the balance by setting different blowing parameters of the two ends.

In some embodiments, the second processing device 112 may be configured to determine an operation stability of the roller based on the motion information; and determine a rotation parameter of the motor 34 based on the operation stability.

More descriptions regarding the motion information and the rotation parameter of the motor 34 may be found in FIG. 14 and the related descriptions thereof.

The operation stability reflects a degree of stability during rotation of the roller.

In some embodiments, the second processing device 112 may determine a motion trajectory of a gravity center of the roller based on a relative position relationship of a point where the gyroscope 122 is located with respect to the gravity center of the roller 1 and the motion information; and determine the operation stability based on the motion trajectory of the gravity center of the roller 1.

The roller 1 may be a rigid body. The position of the gyroscope 122 with respect to the gravity center of the roller 1 may be fixed. The motion trajectory of the gravity center of the roller 1 may be determined based on the motion information of the gyroscope 122 and a motion law of the roller. For example, the motion trajectory of the gravity center of the roller 1 may be determined by simulation software based on the motion information of the gyroscope 122 and the motion law of the roller 1.

In some embodiments, the operation stability may be negatively correlated with a range of the motion trajectory of the gravity center of the roller 1. In an ideal state, the gravity center of the roller 1 rotates with a constant position, and the motion trajectory of the roller 1 is a point. In practical application, the gravity center may be shifted, and the smaller the range of the motion trajectory of the gravity center of the roller 1, the more stable the whole roller 1, and the higher the operation stability. The range of the motion trajectory refers to a region area enclosed by a periphery of the motion trajectory.

For example, the second processing device 112 may determine an inverse of the range of the motion trajectory as the operation stability.

In some embodiments, the second processing device 112 may determine the rotation parameter of the motor 34 by querying a second parameter table based on the operation stability. The second parameter table may include rotation parameters corresponding to different operation stabilities. The second parameter table may be constructed based on a historical rotation record. The historical rotation record may include an operation stability before rotation and an operation stability after rotation of the motor 34. If the operation stability after rotation is greater than a stability threshold, the operation stability and the rotation parameter before adjustment in the historical rotation record may be saved to the second parameter table. The stability threshold may be preset by a technician based on experience.

In some embodiments, the second processing device 112 may be further configured to determine a material drop concentration ratio based on a pressure data sequence of a third preset time period; predict a stability range of a fourth preset time period through a stability model based on the drop concentration ratio, a current angle of permanent magnetic shafts, and the blowing parameter; and determine the rotation parameter based on the stability range. The stability model may be a machine learning model.

The third preset time period is a past time period that is relatively close to the current moment. A duration of the third preset time period may be set based on experience, e.g. 1 h. For example, the current moment is 9:00, and the third preset time period is 8:00-9:00. The pressure data sequence of the third preset time period is a sequence consisting of pressure data at a plurality of consecutive moments within the third preset time period. The pressure data may be obtained by the plurality of pressure sensors 123.

The drop concentration ratio reflects a degree of concentration of the drop concentration position. The drop concentration ratio may be determined based on a range of the material drop position. The smaller the range of the material drop position, the higher the material drop concentration ratio. More descriptions regarding the method of determining the material drop position may be found in FIG. 16 and the related descriptions thereof.

The current angle of the permanent magnetic shafts may be measured by an angle sensor. More descriptions regarding the blowing parameter may be found in FIG. 14 and the related descriptions thereof.

The fourth preset time period is a time period in the future. The fourth preset time period may correspond to the third preset time period, i.e., a duration of the fourth preset time period may be the same as the duration of the third preset time period. For example, if the third preset time period is current 8:00-9:00, the fourth preset time period may be 8:00-9:00 a day later. The stability range is a range of predicted values of the operation stability within the fourth preset time period.

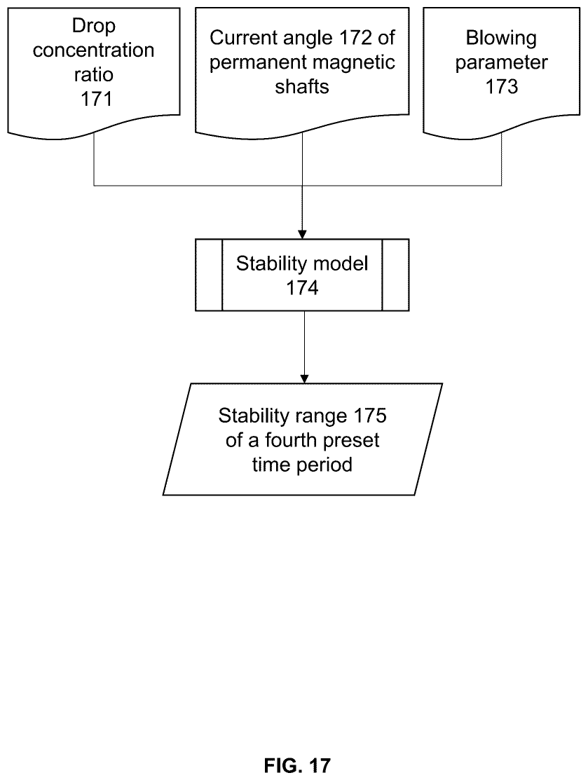

FIG. 17 is a schematic diagram illustrating an exemplary stability model according to some embodiments of the present disclosure.

A stability model 174 is a model for predicting a stability range 175. In some embodiments, the stability model 174 may be a deep neural networks (DNN) model, or the like. In some embodiments, an input of the stability model 174 may include a drop concentration ratio 171, a current angle 172 of permanent magnetic shafts, and a blowing parameter 173, and an output of the stability model 174 may include the stability range 175 of a fourth preset time period.

The blowing parameter may include a current blowing parameter and a future blowing parameter. The second processing device 112 may use a blowing parameter determined based on a second concentration sequence as the future blowing parameter. More descriptions regarding determining the blowing parameter based on the second concentration sequence may be found in FIG. 16 and the related descriptions thereof.

In some embodiments, the stability model 174 may be obtained by training a large number of second training samples and second labels corresponding to the second training samples. Specific training method may be similar to that for the prediction model. More descriptions may be found in FIG. 16 and the related descriptions thereof.

A drop concentration ratio, an angle of the permanent magnetic shafts 22, and a blowing parameter during an actual operation of the roller in a first historical time period may be collected as the second training samples, and actual operation stabilities at a plurality of consecutive moments in a second historical time period may be used as the training labels. The first historical time period may precede the second historical time period.

In some embodiments, the second processing device 112 may determine a rotation parameter by query a second parameter table based on a maximum value in the stability range. More descriptions regarding the second parameter table may be found in the present disclosure above.

In some embodiments, an effective duration of the rotation parameter may be determined based on a dust concentration increase rate, and the dust concentration increase rate may be determined based on a second concentration sequence.

The effective duration of the rotation parameter is a duration from the time the rotation parameter is executed to the time the next new rotation parameter is determined.

In some embodiments, the second processing device 112 may calculate a duration from the time that the current dust concentration increases to the time when the dust concentration reaches a preset concentration threshold as the effective duration based on the dust concentration increase rate. More descriptions regarding the dust concentration increase rate my be found in FIG. 16 and the related descriptions thereof.

Before the next time the preset concentration threshold is reached, the external air source starts blowing, and the airflow has an impact on the stability of the buffer roller, so a new rotation parameter needs to be redetermined before the next time the preset concentration threshold is reached, so as to ensure stable rotation of the roller.

Some embodiments of the present disclosure further provide a control system of a permanent magnetic levitation buffer roller. The control system may include the permanent magnetic levitation buffer roller, a monitoring device, and a control device.

In some embodiments, the permanent magnetic levitation buffer roller may include a roller, a permanent magnetic drum, a magnetic base, a positioner, and a release ring. The permanent magnetic drum may be fixedly mounted on two ends of the roller. The roller may be located on the magnetic base. The magnetic base may be magnetically cooperated with the permanent magnetic drum. A conveyor belt may be sleeved in the middle of the roller. The positioner may have a silo structure. The positioner and the permanent magnetic drum may be coaxially arranged. The positioner may be slidably mounted on the magnetic base. One side of the magnetic base away from the roller may be fixedly provided with an axial rod. The positioner may be slidably mounted on the axial rod. One side of the positioner facing the permanent magnetic drum may be uniformly provided with at least one air nozzle. The release ring may be fixedly mounted on an end portion of the permanent magnetic drum. At least one release groove may be circumferentially disposed on an edge of the release ring.

Each of the at least one air nozzle may correspond to each of the at least one release groove. The at least one release groove may gradually contract in a direction toward an outer side of the release ring. More descriptions regarding the permanent magnetic levitation buffer roller may be found in FIGS. 1-13 and the related descriptions thereof.

In some embodiments, the monitoring device may be disposed on the permanent magnetic levitation buffer roller and configured to collect transportation state information of the permanent magnetic levitation buffer roller and send the transportation state information to the control device.

In some embodiments, the control device may include a first processing device and a second processing device. The first processing device may be configured to determine a blowing parameter based on the transportation state information, and control an external air source connected with the at least one air nozzle of the permanent magnetic levitation buffer roller to blow air to the roller based on the blowing parameter. The second processing device may be configured to determine a rotation parameter based on the transportation state information, and control a motor of the permanent magnetic levitation buffer roller to rotate based on the rotation parameter. More descriptions regarding the monitoring device and the control device may be found in FIGS. 14-17 and the related descriptions thereof.

Having thus described the basic concepts, it may be rather apparent to those skilled in the art after reading this detailed disclosure that the foregoing detailed disclosure is intended to be presented by way of example only and is not limiting.

Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, “some embodiments” mean that a particular feature, structure, or feature described in connection with the embodiment is included in at least one embodiment of the present disclosure. Therefore, it is emphasized and should be appreciated that two or more references to “some embodiments” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be noted that in order to simplify the presentation of the disclosure of the present disclosure, and thus assist in the understanding of one or more embodiments of the present disclosure, the foregoing descriptions of embodiments of the present disclosure sometimes group multiple features together in a single embodiment, accompanying drawings, or a description thereof. Rather, claimed subject matter may lie in less than all features of a single foregoing disclosed embodiment.

In some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A permanent magnetic levitation buffer roller, comprising a roller, a permanent magnetic drum, a magnetic base, a positioner, and a release ring, wherein
the permanent magnetic drum is fixedly mounted on two ends of the roller, the roller is located on the magnetic base, the magnetic base is magnetically cooperated with the permanent magnetic drum, and a conveyor belt is sleeved in the middle of the roller;
the positioner has a silo structure, the positioner and the permanent magnetic drum are coaxially arranged, the positioner is slidably mounted on the magnetic base, one side of the magnetic base away from the roller is fixedly provided with an axial rod, the positioner is slidably mounted on the axial rod, and one side of the positioner facing the permanent magnetic drum is uniformly provided with at least one air nozzle;
the release ring is fixedly mounted on an end portion of the permanent magnetic drum, at least one release groove is circumferentially disposed on an edge of the release ring, each of the at least one air nozzle corresponds to each of the at least one release groove, and the at least one release groove gradually contracts in a direction toward an outer side of the release ring.

2. The permanent magnetic levitation buffer roller of claim 1, further comprising a light sensor, wherein the light sensor is fixedly mounted at a center of the end portion of the permanent magnetic drum, and a light source emitter cooperated with the light sensor is fixedly mounted on the side of the positioner facing the permanent magnetic drum.

3. The permanent magnetic levitation buffer roller of claim 1, wherein the axial rod is uniformly provided with pin holes in a direction of a central axis of the axial rod, and a bottom of the positioner is provided with pins matching the pin holes.

4. The permanent magnetic levitation buffer roller of claim 3, wherein at least one positioning groove is axially provided on the side of the positioner facing the permanent magnetic drum, each of the at least one air nozzle is slidably mounted in each of the at least one positioning groove, a positioning disk is slidably mounted in the positioner, the positioning disk is hinged with the at least one air nozzle through at least one connecting rod, an electric actuator is fixedly mounted in the positioner, and one end of the electric actuator fixedly connected with the positioning disk.

5. The permanent magnetic levitation buffer roller of claim 4, wherein one end of the positioner away from the permanent magnetic drum is provided with a closed cavity, an end cap is fixedly provided at one end of the closed cavity away from the permanent magnetic drum, and a plurality of filter cartridges are fixedly mounted in the closed cavity.

6. The permanent magnetic levitation buffer roller of claim 5, wherein each of the at least one air nozzle is communicated with the closed cavity of the positioner through a hose, an intake pipe is fixedly mounted on the end cap, and an inlet end of the intake pipe is communicated with a central region of each of the plurality of filter cartridges.

7. The permanent magnetic levitation buffer roller of claim 2, wherein one side of the permanent magnetic drum facing the positioner is provided with a circumferential separation ring, a cross section of the separation ring is tapered, and the separation ring is disposed at a periphery of the light sensor.

8. The permanent magnetic levitation buffer roller of claim 1, wherein the permanent magnetic drum includes magnetic tiles and permanent magnets, the magnetic tiles and the permanent magnets being staggered inside the permanent magnetic drum.

9. The permanent magnetic levitation buffer roller of claim 8, wherein a sinking groove communicating vertically is provided in the middle of the magnetic base, the permanent magnetic drum is located directly above the sinking groove, and an upper portion of a mouth of the sinking groove is symmetrically provided with slope structures, and slope surfaces of the slope structures are parallel to a central axis of the permanent magnetic drum.

10. The permanent magnetic levitation buffer roller of claim 9, wherein a width of the sinking groove is less than an outer diameter of the permanent magnetic drum.

11. The permanent magnetic levitation buffer roller of claim 9, wherein permanent magnetic shafts are rotationally mounted on two sides of the magnetic base, the permanent magnetic shafts are located below the slope structures, the permanent magnetic shafts, the magnetic tiles, and the permanent magnets are magnetically cooperated, a motor is fixedly mounted on one side of the magnetic base, and an output shaft of the motor is fixedly connected with each of the permanent magnetic shafts.

12. The permanent magnetic levitation buffer roller of claim 11, wherein a plurality of bearing shafts are rotationally mounted on the slope surfaces of the slope structures, the bearing shafts rotationally fit an outer wall of the permanent magnetic drum, a ball plunger is rotationally mounted on one end of each of the bearing shafts close to the release ring, and an end portion of the ball plunger fits an outer wall of the release ring in a rolling manner.

13. The permanent magnetic levitation buffer roller of claim 11, wherein a shield ring is fixedly mounted on an upper portion of the magnetic base, the shield ring surrounds a periphery of the permanent magnetic drum, a cotton plate is movably mounted below the slope structures, and the cotton plate is located below the shield ring.

14. The permanent magnetic levitation buffer roller of claim 11, wherein evacuation holes are uniformly disposed on one side of the magnetic base facing the positioner, a wiping cavity is disposed on an inner side of the magnetic base, a plurality of wiping rods are fixedly mounted in the wiping cavity, the plurality of wiping rods are arranged around the permanent magnetic shafts, and an end portion of each of the evacuation holes is communicated with the wiping cavity.

15. The permanent magnetic levitation buffer roller of claim 14, wherein a waste chip chute and a waste chip box are disposed at a bottom of the magnetic base, the waste chip chute being communicated with the wiping cavity, and the waste chip box being located below the waste chip chute.

16. The permanent magnetic levitation buffer roller of claim 15, wherein the at least one release groove is located on an outer side of the evacuation holes, a through hole pointing to the evacuation holes is provided at a bottom of the at least one release groove, and the cotton plate is located between the evacuation holes and the waste chip chute.

17. The permanent magnetic levitation buffer roller of claim 1, wherein the permanent magnetic levitation buffer roller is controlled by a control device, and the control device includes a first processing device and a second processing device; wherein
the first processing device is configured to control an external air source connected with the at least one air nozzle of the permanent magnetic levitation buffer roller to blow air to the roller based on a blowing parameter; and
the second processing device is configured to control a motor of the permanent magnetic levitation buffer roller to rotate based on a rotation parameter.

18. The permanent magnetic levitation buffer roller of claim 17, wherein the rotation parameter is determined based on transportation state information of the permanent magnetic levitation buffer roller, the transportation state information being collected by a monitoring device, and the transportation state information including a dust concentration, pressure data, and motion information.

19. The permanent magnetic levitation buffer roller of claim 18, wherein the monitoring device includes a dust monitoring device, a gyroscope, and a plurality of pressure sensors; wherein
the dust monitoring device is configured to collect the dust concentration in real time;
the gyroscope is disposed in the roller and configured to monitor the motion information; and
the plurality of pressure sensors are disposed on an outer surface of the roller and configured to collect the pressure data.

20. A control system of a permanent magnetic levitation buffer roller, comprising the permanent magnetic levitation buffer roller, a monitoring device, and a control device; wherein
the permanent magnetic levitation buffer roller includes a roller, a permanent magnetic drum, a magnetic base, a positioner, and a release ring, wherein
the permanent magnetic drum is fixedly mounted on two ends of the roller, the roller is located on the magnetic base, the magnetic base is magnetically cooperated with the permanent magnetic drum, and a conveyor belt is sleeved in the middle of the roller;
the positioner has a silo structure, the positioner and the permanent magnetic drum are coaxially arranged, the positioner is slidably mounted on the magnetic base, one side of the magnetic base away from the roller is fixedly provided with an axial rod, the positioner is slidably mounted on the axial rod, and one side of the positioner facing the permanent magnetic drum is uniformly provided with at least one air nozzle;
the release ring is fixedly mounted on an end portion of the permanent magnetic drum, at least one release groove is circumferentially disposed on an edge of the release ring, each of the at least one air nozzle corresponds to each of the at least one release groove, and the at least one release groove gradually contracts in a direction toward an outer side of the release ring;
the monitoring device is disposed on the permanent magnetic levitation buffer roller and configured to collect transportation state information of the permanent magnetic levitation buffer roller and send the transportation state information to the control device;
the control device includes a first processing device and a second processing device; wherein
the first processing device is configured to determine a blowing parameter based on the transportation state information, and control an external air source connected with the at least one air nozzle of the permanent magnetic levitation buffer roller to blow air to the roller based on the blowing parameter; and
the second processing device is configured to determine a rotation parameter based on the transportation state information, and control a motor of the permanent magnetic levitation buffer roller to rotate based on the rotation parameter.
